(19) United States
(12) Patent Application Publication
(10) Pub. No.: US 2011/0060519 A1
(43) Pub. Date: Mar. 10, 2011

(54) NAVIGATION DEVICE AND METHOD OF UPDATING THEREFOR

(76) Inventor: Raymond Hunter, Amsterdam (NL)

(21) Appl. No.: 12/736,397

(22) PCT Filed: Apr. 16, 2009
(86) PCT No.: PCT/EP2009/054530

§ 371 Date: Nov. 15, 2010

Related U.S. Application Data
(60) Provisional application No. 61/071,763, filed on May 16, 2008.

(51) Int. Cl. G01C 21/00; G06F 15/16

(52) U.S. Cl. 701/200; 709/219

(57) ABSTRACT

A navigation device is capable of a first level of operation and a second level of operation. In at least one embodiment, the device includes a processing resource arranged to support, when in use, an operational environment. The device also includes a data store operably coupled to the processing resource and arranged to store updatable data useable by the operational environment. The device further includes a communications network interface for supporting connectivity with a subscription-free communications network. The first level of operation consumes less power than the second level of operation, and the processing resource supports an activation module arranged to cause a transition from the first level of operation to the second level of operation. The processing resource is also arranged to use the communications network interface following the transition to the second level of operation in order to download data.

This is a National Phase application of PCT Patent Application No. PCT/EP2009/054530, filed on Apr. 16, 2009, which claims priority under 35 U.S.C. §119(e) to U.S. Provisional Application No. 61/071,763, filed on May 16, 2008, the contents of each of which are hereby incorporated herein by reference in their entirety.

### FIELD OF THE INVENTION

The present invention relates to a navigation device of the type that, for example, requires files to be downloaded in order to update data stored thereon. The present invention also relates to a method of updating a navigation device of the type, the method being of the type that, for example, requires data to be downloaded in order to update data stored by the navigation device.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function. During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route recalculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria: for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Such devices are of great utility when the user is not familiar with the route to the destination to which they are navigating. However, when using the PND it is desirable that information retained in the memory of the PND is as up-to-date as possible. In this respect, it is known to download updates to information stored and used by a PND, for example weather information, static traffic information, map data updates and/or information relating to positions of satellites, for example the so-called QuickGPSfix data available from TomTom International BV in respect of certain PND devices, for example TomTom model numbers 920, 720, 520, 910, 710, 510 and ONE (XL, Third and Second Editions).

In this respect, in order to maintain the above-mentioned information, one known download facility is provided by TomTom International BV through a software application known as “TomTom Home”. TomTom Home provides access to a number of services and a global community of users of TomTom PNDs. Through the TomTom Home application, a user can manage, update and personalise a PND, for example a facility is provided, inter alia, to download and install map content, software updates, QuickGPSfix data and safety camera location information as well as other content. The TomTom Home application also allows owners of TomTom PNDs to purchase premium content, for example additional announcement voices, fuel price data and static traffic information, the content once purchased requiring regular downloading of updates to remain up-to-date and useful. However, use of the TomTom Home application requires proactive steps to be taken by a user of the PND in order to download update data to the PND and then install the update data. In some circumstances, certain types of data can be downloaded automatically during use of the PND using a data service supported by a cellular communications network, for example a General Packet Radio Service (GPRS) or and Enhanced Data rates for GSM Evolution (EDGE) service or the High-Speed Downlink Packet Access (HSDPA) service. However, such data services are payable on a per-use basis, charges being made to a subscriber per megabyte of data downloaded, a low initial data allowance being included in an initial monthly fee for the data service. Consequently, the subscriber and typically also the user of the PND is charged based upon the volume data downloaded to the PND. Hence, an otherwise economic service provided by a PND manufacturer or other service provider becomes increasingly expensive due to expensive data charges incurred in order to obtain the data provided in relation to the service. Additionally, a user that has connected the PND to the remote server can inadvertently download data via the data service and unexpectedly incur data charges.

### SUMMARY OF THE INVENTION

According to a first aspect of the present invention, there is provided a navigation device capable of a first level of operation and a second level of operation, the device comprising: a processing resource arranged to support, when in use, an operational environment; a data store operably coupled to the processing resource and arranged to store updatable data useable by the operational environment; and a communications network interface for supporting connectivity with a subscription-free communications network; wherein the first level of operation consumes less power than the second level of operation; the processing resource supports an activation module arranged to cause a transition from the first level of operation to the second level of operation: and the processing resource is arranged to use the communications network interface following the transition to the second level of operation in order to download data.

The processing resource may be arranged to use at least part of the downloaded data to update at least part of the updatable data. The processing resource may comprise a processor that supports the activation module, or the activation module may be supported by another part of the processing resource.

The first level of operation may be a dormant state, for example a standby state or a powered-down state. The second level of operation may be an active state, for example a powered-up state.

The operational environment may be provided by application software, for example application software to support navigation, route planning, location determination and/or map display.

The subscription-free communications network may be capable of permitting communication via another communications network, the download of the data being via both the subscription-free communications network and the another communications network. The another communications network may be subscription based; the subscription associated with the another communications network may be a flat-fee based subscription. The subscription associated with the another communications network may be unmetered. The subscription associated with the another communications network may have a download limit or threshold, for example about 1 GB or 2 GB. For the purposes of defining the term “unmetered”, the unmetered aspect of the subscription may not include measurement to determine whether a maximum download threshold may have been reached or exceeded.

The subscription associated with the another communications network may be a home or office “broadband” communications subscription. The domestic broadband communications subscription may be provided by a wireline broadband Internet Service Provider.

The subscription-free communications network may be a domestic communications network, for example a wireless domestic communications network.

The subscription-free communications network may be a local area network. The local area network may be a wireless local area network.

The communications network interface may be a local area network communications interface, for example a wireless local area network communications interface. The communications network interface may support communications in accordance with an IEEE 802.11x standard, where x designates a particular standard from the 802.11 family of standards, for example 802.11a, 802.11b, 802.11c, 802.11g or 802.11n. The communications network interface may be a personal area network communications interface, for example a communications network supported by the Bluetooth standard.

The data may be downloaded from a remote source of data. The remote source of data may be a server. The updatable data may be dynamic data.

The updatable data may be updatable content. The dynamic data may vary in content over time. The updatable data may comprise calibration data, for example data relating to a position of a satellite, such as so-called QuickGPSfix data available from TomTom International B.V. The updatable data may comprise environmental data, for example meteorological data, such as data relating to weather. At least part of the updatable data may relate to traffic data. The traffic data may be static, for example time-invariant. The updatable data may comprise map data. The updatable data may comprise safety data, for example data relating to a location of a safety camera, such as data relating to a last known location of a mobile safety camera.

The communications network interface may be used in response to the transition to the second level of operation. The activation module may generate a wake signal; the transition from the first level of operation to the second level of operation may be in response to the wake signal.

The activation module may be arranged to cause the transition from the first level of operation to the second level of operation automatically.

The activation module may be arranged to cause the transition at a predetermined time. The predetermined time may be set by a user, for example using the operational environment.

The processing resource may be arranged to learn an activation time during a day or night when a user causes the navigation device to transition from the first level of operation to the second level of operation, for example when the navigation device may be powered up. The processing resource may be arranged to observe a plurality of times when the transition caused by the user takes place and to calculate the activation time from the plurality of times observed.

The processing resource may be arranged to process the plurality of times observed in order to discount or mitigate influence of any substantially anomalous times, or any times deviating by more than a predetermined time threshold from a clustering of times of the plurality of times. The predetermined time threshold may be a selected value or a function, for example a multiple or percentage.

The plurality of times or the processed plurality of times may be averaged in order to yield the activation time, for example determining a mean time when the transition caused by the user takes place, a mode time when the transition caused by the user takes place or an earliest time relative to a period of a day or night, for example after about midnight, when the transition caused by the user takes place.

The predetermined time may be determined to precede the activation time by a pre-activation time period. The pre-activation time period may be a fixed period of time. The fixed period of time may be selectable.

The processing resource may be arranged to determine the size of the data to be downloaded and use the size of the data to be downloaded to determine whether sufficient time remains before the activation time in order to download the data. Where the data to be downloaded comprises separately downloadable parts, the processing resource may be arranged to prioritise download of the separately downloadable parts and/or defer download of a downloadable part of the separately downloadable parts in response to insufficient time being available to download all the separately downloadable parts before the activation time. The prioritisation of the separately downloadable parts may be selected by a user, for example via the operational environment.

The processing resource may be arranged to calculate the pre-activation time period. The processing resource may be arranged to determine the size of the data to be downloaded and use the size of the data to be downloaded to determine the pre-activation time period. The processing resource may be arranged to determine the size of the data to be downloaded in advance of the predetermined time, for example an amount of time in advance of the activation time that may be a multiple of a maximum anticipated download time for the data to be downloaded or at a set time when the navigation device may be unlikely to be used, such as between about 2:00 am and about 4:00 am. The processing resource may be arranged to estimate size of at least part of the data to be download, for example a part of the data to be downloaded unavailable at a time when determination of the size of the data to be downloaded is attempted, such as data relating to traffic. For the avoidance of doubt, the estimated size of the unavailable part of the data to be downloaded may be used to determine the size of the data to be downloaded. The processing resource may be arranged to determine the pre-activation time period using the determined size of the data to be downloaded and knowledge of an obtainable download speed; the obtainable download speed may be provided by the user via the operational environment or calculated by the processing resource, for example using experience of a previously obtained download speed or a download speed test.

According to a second aspect of the present invention, there is provided a method of updating a navigation device capable of a first level of operation and a second level of operation, the method comprising: supporting an operational environment; storing updatable data in a data store useable by the operational environment; providing a communications network interface for supporting connectivity with a subscription-free communications network; providing an activation module to cause a transition from the first level of operation to the second level of operation; and using the communications network interface following the transition to the second level of operation in order to download data; wherein the first level of operation consumes less power than the second level of operation.

According to a third aspect of the present invention, there is provided a computer program element comprising computer program code means to make a computer execute the method as set forth in accordance with the second aspect of the invention.

The computer program element may be embodied on a computer readable medium.

According to a fourth aspect of the present invention, there is provided a communications system comprising: a navigation device as set forth above in relation to the first aspect of the invention; a first communications network capable of communicating with the navigation device; a second communications network operably coupled to the first communications network and capable of passing communications between the navigation device and a remote source of data; wherein the first communications network is subscription free.

The second communications network may have an unmetered or flat-fee subscription associated therewith. The unmetered aspect of the subscription may not include measurement to determine whether a maximum download threshold may have been reached or exceeded.

Advantages of these embodiments are set out hereafter, and further details and features of each of these embodiments are defined in the accompanying dependent claims and elsewhere in the following detailed description.

It is thus possible to provide a navigation device and a method of updating a navigation device that obtains data from a remote source in a more convenient manner than existing data download techniques for navigation devices. Additionally, the data is downloaded in a more cost-effective manner, thereby reducing data charges incurred by the user and/or a subscriber to a wireless communications network by taking advantage of an existing subscription to a communications network having surplus capacity for downloading data without incurring additional charges for download of the data. Furthermore, the updatable data is regularly updated as opposed to being updated on an ad-hoc basis by the user, resulting in an increased probability of the PND storing data that is up-to-date.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation device;

FIG. 2 is a schematic illustration of electronic components of a navigation device constituting an embodiment of the invention;

FIG. 3 is a schematic diagram of a navigation device;

FIG. 4 is a schematic illustration of the manner in which a navigation device may receive information over a wireless communication channel;

FIG. 5 is a schematic representation of an architectural stack employed by the navigation device;

FIG. 6 is a flow diagram of a method of configuring the navigation device of FIG. 2;

FIG. 7 is a schematic diagram of a communications system employing the navigation device of FIG. 2;

FIG. 8 is a schematic diagram of part of the contents of a data store of the navigation device of FIG. 2;

FIG. 9 is a flow diagram of a method of downloading data for use with the navigation device of FIG. 2;

FIG. 10 is schematic diagram of part of a processing resource of the navigation device of FIG. 2;

FIG. 11 is a flow diagram of a method of collecting activation times constituting part of another embodiment of the invention;

FIG. 12 is a flow diagram of a method of analysis of activation times constituting another part of the another embodiment of the invention; and

FIG. 13 is a flow diagram of a method of determining a download time constituting a further embodiment of the invention.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings of the present invention are not limited to PNDs but are instead universally applicable to any type of processing device that is configured to execute navigation software in a portable manner so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention even have utility in circumstances, where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. As mentioned above, the GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

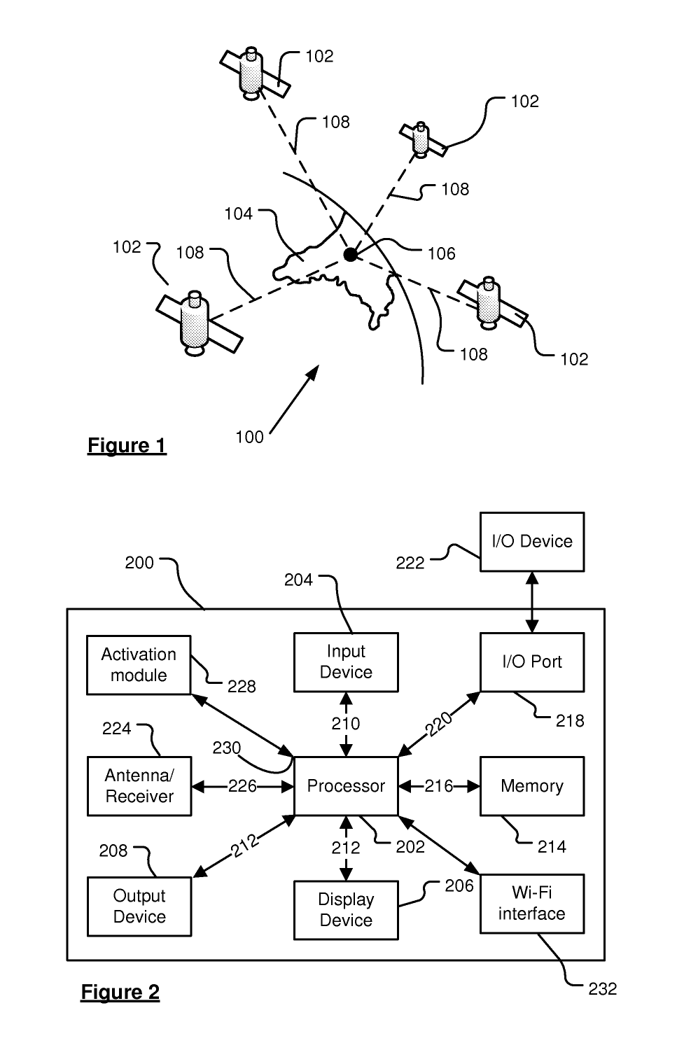

Referring to FIG. 2, it should be noted that the block diagram of the navigation device 200 is not inclusive of all components of the navigation device, but is only representative of many example components. The navigation device 200 is located within a housing (not shown). The navigation device 200 includes a processing resource comprising, for example, a processor 202, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

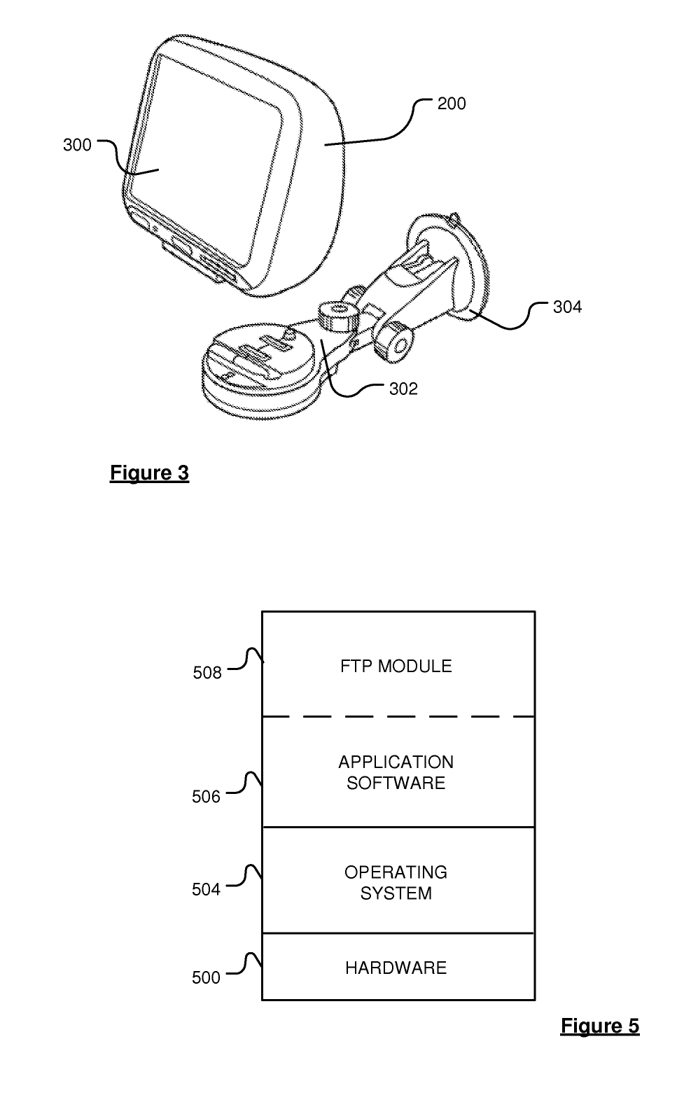

In one arrangement, one aspect of the input device 204, the touch panel, and the display screen 206 are integrated so as to provide an integrated input and display device, including a touchpad or touchscreen input 300 (FIG. 3) so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation apparatus 200, the processor 202 is operatively connected to and capable of receiving input information from input device 204 via a connection 210, and operatively connected to at least one of the display screen 206 and an output device 208, via respective output connections 212, to output information thereto. The output device 208 is, for example, an audible output device (e.g. including a loudspeaker). As the output device 208 can produce audible information for a user of the navigation apparatus 200, it should equally be understood that input device 204 can include a microphone and software for receiving input voice commands as well. The processor 202 is operably coupled to a memory resource 214 via connection 216 and is further adapted to receive/send information from/to input/output (I/O) ports 218 via connection 220, wherein the I/O port 218 is connectible to an I/O device 222 external to the navigation apparatus 200. The memory resource 214 comprises, for example, a volatile memory, such as a Random Access Memory (RAM) and a non-volatile memory, for example a digital memory, such as a flash memory. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile phone for example, wherein the mobile phone connection can be used to establish a data connection between the navigation device 200 and the internet or any other network for example, and/or to establish a connection to a server via the internet or some other network for example.

FIG. 2 further illustrates an operative connection between the processor 202 and an antenna/receiver 224 via connection 226, wherein the antenna/receiver 224 can be a GPS antenna/receiver for example. It will be understood that the antenna and receiver designated by reference numeral 224 are combined schematically for illustration, but that the antenna and receiver may be separately located components, and that the antenna may be a GPS patch antenna or helical antenna for example.

In order to support the functionality described herein, the processing resource also comprises an activation module 228. In this example, the activation module 228 is implemented separately from the processor 202, for example a programmable wake-up circuit having a clock circuit (not shown) and capable of generating a wake signal that is receivable by the processor 202 via a wake input 230 of the processor 202. However, the skilled person should appreciate that the functionality of the activation module 228 can be incorporated into a part of the processor 202 in the event that a part of the processor 202 is capable of operating at a different level of operation to another part of the processor 202.

A Communications network interface 232 is also provided and operably coupled to the processor 202. In this example, the communications network interface 232 is a wireless communications network interface 232 operably coupled to a communications circuit (not shown) comprising a wireless communications transceiver (also not shown). However, the skilled person should appreciate that the communications circuit need not be internal to the navigation device 200 and can be coupled to the navigation device 200 via an input/output port, for example of the type similar to the input/output port 218.

It will, of course, be understood by one of ordinary skill in the art that the electronic components shown in FIG. 2 are powered by one or more power sources (not shown) in a conventional manner. As will be understood by one of ordinary skill in the art, different configurations of the components shown in FIG. 2 are contemplated. For example, the components shown in FIG. 2 may be in communication with one another via wired and/or wireless connections and the like. Thus, the navigation device 200 described herein can be a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use. Referring to FIG. 3, the navigation device 200 may be a unit that includes the integrated input and display device 300 and the other components of FIG. 2 (including, but not limited to, the internal GPS receiver 224, the microprocessor 202, a power supply (not shown), memory systems 214, etc.).

The navigation device 200 may sit on an arm 302, which itself may be secured to a vehicle dashboard/window/etc, using a suction cup 304. This arm 302 is one example of a docking station to which the navigation device 200 can be docked. The navigation device 200 can be docked or otherwise connected to the arm 302 of the docking station by snap connecting the navigation device 200 to the arm 302 for example. The navigation device 200 may then be rotatable on the arm 302. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

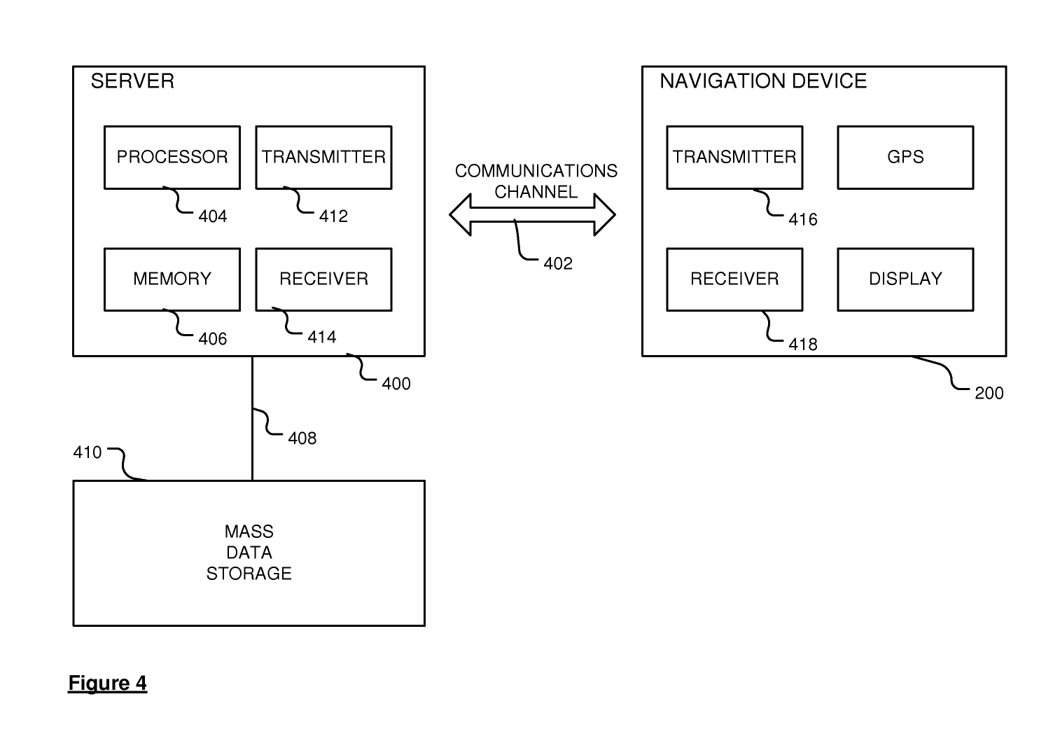

Referring now to FIG. 4, the navigation device 200 may establish a data session with network hardware of a “mobile” or telecommunications network via a mobile device (not shown), for example a mobile telephone. PDA, and/or any device with mobile telephone technology, in order to establish a digital connection, for example a digital connection via known Bluetooth technology. Thereafter, through its network service provider, the mobile device can establish a network connection (through the internet for example) with a server 400. As such, a “mobile” network connection can be established between the navigation device 200 (which can be, and often times is mobile as it travels alone and/or in a vehicle) and the server 400 to provide a “real-time” or at least very “up to date” gateway for information.

The establishing of the network connection between the mobile device (via a service provider) and another device such as the server 400, using the internet for example, can be done in a known manner. In this respect, any number of appropriate data communications protocols can be employed, for example the TCP/IP layered protocol. Furthermore, the mobile device can utilize any number of communication standards such as CDMA2000, GSM, IEEE 802.11a/b/c/g/n, etc.

Hence, it can be seen that the internet connection may be utilised, which can be achieved via data connection, via a mobile phone or mobile phone technology within the navigation device 200 for example.

Of course, the navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module (SIM) card), complete with necessary mobile phone technology and/or an antenna for example. As such, mobile phone technology within the navigation device 200 can similarly establish a network connection between the navigation device 200 and the server 400, via the internet for example, in a manner similar to that of any mobile device.

For GRPS phone settings, a Bluetooth enabled navigation device may be used to work correctly with the ever changing spectrum of mobile phone models, manufacturers, etc., model/manufacturer specific settings may be stored on the navigation device 200 for example. The data stored for this information can be updated.

In FIG. 4, the navigation device 200 is depicted as being in communication with the server 400 via a generic communications channel 402 that can be implemented by any of a number of different arrangements. The communication channel 402 generically represents the propagating medium or path that connects the navigation device 200 and the server 400. The server 400 and the navigation device 200 can communicate when a connection via the communications channel 402 is established between the server 400 and the navigation device 200 (noting that such a connection can be a data connection via mobile device, a direct connection via personal computer via the internet, etc.).

The communication channel 402 is not limited to a particular communication technology. Additionally, the communication channel 402 is not limited to a single communication technology; that is, the channel 402 may include several communication links that use a variety of technology. For example, the communication channel 402 can be adapted to provide a path for electrical, optical, and/or electromagnetic communications, etc. As such, the communication channel 402 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 402 can include intermediate devices such as routers, repeaters, buffers, transmitters, and receivers, for example.

In one illustrative arrangement, the communication channel 402 includes telephone and computer networks. Furthermore, the communication channel 402 may be capable of accommodating wireless communication, for example, infrared communications, radio frequency communications, such as microwave frequency communications, etc. Additionally, the communication channel 402 can accommodate satellite communication.

The communication signals transmitted through the communication channel 402 include, but are not limited to, signals as may be required or desired for given communication technology. For example, the signals may be adapted, to be used in relation to different access schemes and/or cellular communication technology, such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 402. These signals may be modulated, encrypted and/or compressed signals as may be desirable for the communication technology.

The server 400 includes, in addition to other components which may not be illustrated, a processor 404 operatively connected to a memory 406 and further operatively connected, via a wired or wireless connection 408, to a mass data storage device 410. The mass storage device 410 contains a store of navigation data and map information, and can again be a separate device from the server 400 or can be incorporated into the server 400. The processor 404 is further operatively connected to transmitter 412 and receiver 414, to transmit and receive information to and from navigation device 200 via communications channel 402. The signals sent and received may include data, communication, and/or other propagated signals. The transmitter 412 and receiver 414 may be selected or designed according to the communications requirement and communication technology used in the communication design for the navigation system 200. Further, it should be noted that the functions of transmitter 412 and receiver 414 may be combined into a single transceiver.

As mentioned above, the navigation device 200 is arranged to communicate with the server 400 through communications channel 402, and includes processor, memory, etc. as previously described with regard to FIG. 2, as well as transmitter 416 and receiver 418 to send and receive signals and/or data through the communications channel 402, noting that these devices can further be used to communicate with devices other than server 400. Further, the transmitter 416 and receiver 418 are selected or designed according to communication requirements and communication technology used in the communication design for the navigation device 200 and the functions of the transmitter 416 and receiver 418 may be combined into a single transceiver as described above in relation to FIG. 2.

Software stored in server memory 406 provides instructions for the processor 404 and allows the server 400 to provide services to the navigation device 200. One service provided by the server 400 involves processing requests from the navigation device 200 and transmitting navigation data from the mass data storage 410 to the navigation device 200. Another service provided by the server 400 includes processing the navigation data using various algorithms for a desired application and sending the results of these calculations to the navigation device 200.

The server 400 constitutes a remote source of data accessible by the navigation device 200 via a wireless channel. The server 400 may include a network server located on a local area network (LAN), wide area network (WAN), virtual private network (VPN), etc.

The server 400 may include a personal computer such as a desktop or laptop computer, and the communication channel 402 may be a cable connected between the personal computer and the navigation device 200. Alternatively, a personal computer may be connected between the navigation device 200 and the server 400 to establish an internet connection between the server 400 and the navigation device 200.

The navigation device 200 may be provided with information from the server 400 via information downloads which may be periodically updated automatically or upon a user connecting the navigation device 200 to the server 400 and/or may be more dynamic upon a more constant or frequent connection being made between the server 400 and navigation device 200 via a wireless mobile connection device and TCP/IP connection for example. For many dynamic calculations, the processor 404 in the server 400 may be used to handle the bulk of processing needs, however, processor 202 of navigation device 200 can also handle much processing and calculation, oftentimes independent of a connection to a server 400.

As indicated above in relation to FIG. 2, the navigation device 200 includes the processor 202, the input device 204, and the display screen 206. The input device 204 and display screen 206 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 204 and/or any additional output device, such as audio input/output devices for example.

Turning to FIG. 5, the memory resource 214 of the navigation apparatus 200 stores a boot loader program (not shown) that is executed by the processor 202 in order to load an operating system 504 from the memory resource 214 for execution by functional hardware components 500, which provides an environment in which application software 506 can run. The operating system 504 serves to control the functional hardware components 500 and resides between the application software 506 and the functional hardware components 500. The application software 506 provides an operational environment including the GUI that supports core functions of the navigation apparatus 200, for example map viewing, route planning, navigation functions and any other functions associated therewith.

In order to facilitate communication with the server 400, the application software 506 includes, in this example, a file transfer protocol (FTP) module 508. Furthermore, during manufacture or upon first setup of the navigations device 200, the FTP module 508 is provided with a Universal Resource Locator (URL) associated with the server 400.

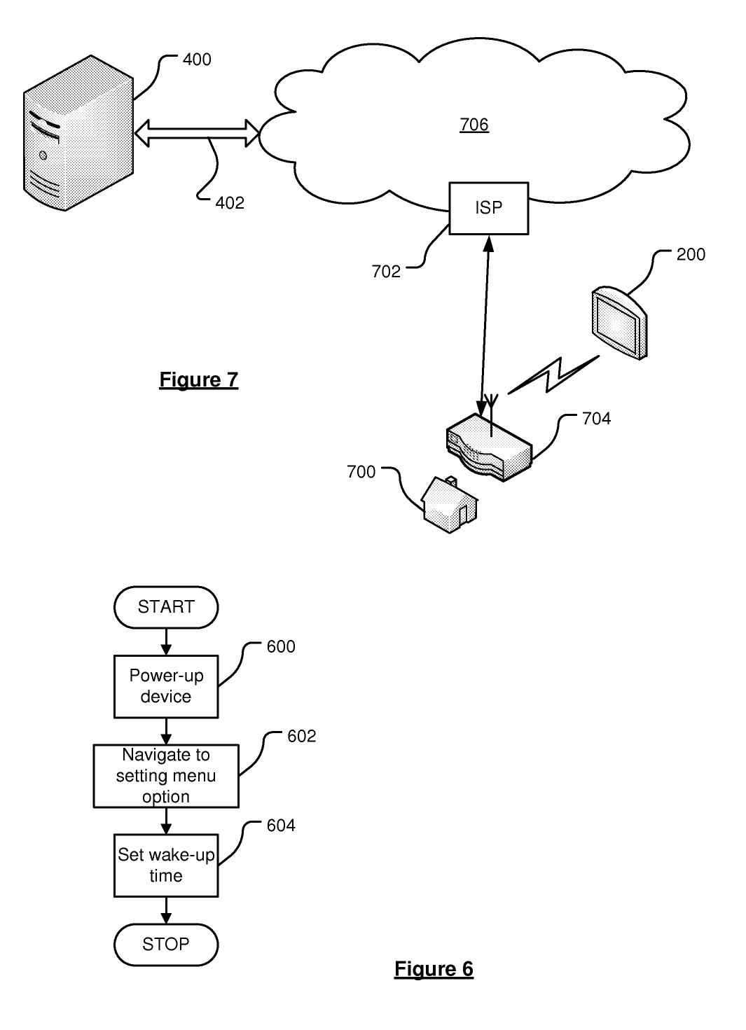

Referring to FIG. 6, and assuming the navigation device 200 is new and unconfigured, or requires re-configuration, the user powers up (Step 600) the navigation device 200 and uses the operational environment provided in order to navigate (Step 602) through a menu structure displayed by the GUI of the operational environment in order to access a settings menu option.

In this example, the settings menu option provides the user with an ability to select a predetermined time, the user setting (Step 604) the predetermined time based upon knowledge of the user of when the device is likely to be unused, for example a period late at night or early in the morning, such as between the hours of about 5.00 am and about 6.00 am. In this respect, the navigation device 200 has multiple levels of operation. The navigation device 200 is capable of a first level of operation when the navigation device 200 is either completely powered-down or in a standby state or a substantially dormant state. The navigation device 200 is also capable of a second level of operation in which at least part of the navigation device 200 is in an active state, for example a powered-up state and capable of normal operation. The first level of operation therefore consumes less power than the second level of operation.

Typically, the navigation device 200 is brought into a domestic environment, for example a home 700 (FIG. 7), at the end of a day once the user has finished using the navigation device 200, for example to avoid theft of the navigation device 200 from a vehicle. In the home 700, the user has access to a broadband internet connection provided by an Internet Service Provider (ISP) 702 of which the user is a subscriber. The subscription to the ISP 702 is based upon a monthly tariff and data transfer is not charged by the ISP 702 on a volume of data basis, though some ISPs have an upper limit for data download, for example 1 GB or 2 GB, which if abused on a regular basis results in additional charges being levied by the ISP 702. Consequently, the download of data via the ISP 702, from a charging perspective, is effectively unmetered, the determination whether a maximum download threshold has been reached or exceeded is not considered herein as metering. In this example, the broadband connection is provided on a wireline basis. A communications network provided by the ISP is, in this example, an Ethernet based network, for example a Gigabit Ethernet network. Alternatively, the technology employed can be Asymmetric Digital Subscriber Line (ADSL) or Symmetric Digital Subscriber Line (SDSL). Additionally, the level of service provided by the ISP 702 need not be limited to a domestic level of service and a business level of service can be used. Likewise, although this example is being described in the context of the home 700, the navigation device 200 can be “rested” in an office or business environment.

At the home 700, a subscription-free communications network is provided supported by, for example, a wireless router 704. The subscription-free communications network constitutes a domestic communications network. In this example, the subscription-free communications network is a Local Area Network (LAN), for example a wireless LAN. The communications network interface 232 and hence the wireless communications transceiver (not shown), operably coupled to the wireless network interface 232, are capable of operating in the wireless LAN. Furthermore, in this example, the wireless LAN is an IEEE 802.11n compliant wireless LAN, though the skilled person should appreciate that any suitable wireless standard can be employed to support the subscription-free communications network, for example IEEE 802.11a, 802.11b, 802.11c or 802.11g standards from the IEEE 802.11x family of standards.

The wireless router 704 is operably coupled to the ISP 702, the ISP 702 providing access to the Internet 706. The server 400 is therefore accessible from the home 700.

Turning to the server 400, the server 400 stores data available for download by the navigation device 200. In this respect, the download data can be a number of update data files. The number of data files can be packaged as a single file, the single file being in a compressed format, for example a so-called ZIP file. The number of files can comprise data that is available for download by the navigation device 200 as part of an update service. The navigation device 200 stores, in the memory 214, corresponding updatable data that can be updated using at least part of the number of update data files. The updatable data is dynamic data constituting content that can vary with time, but not “live” data varying in real-time.

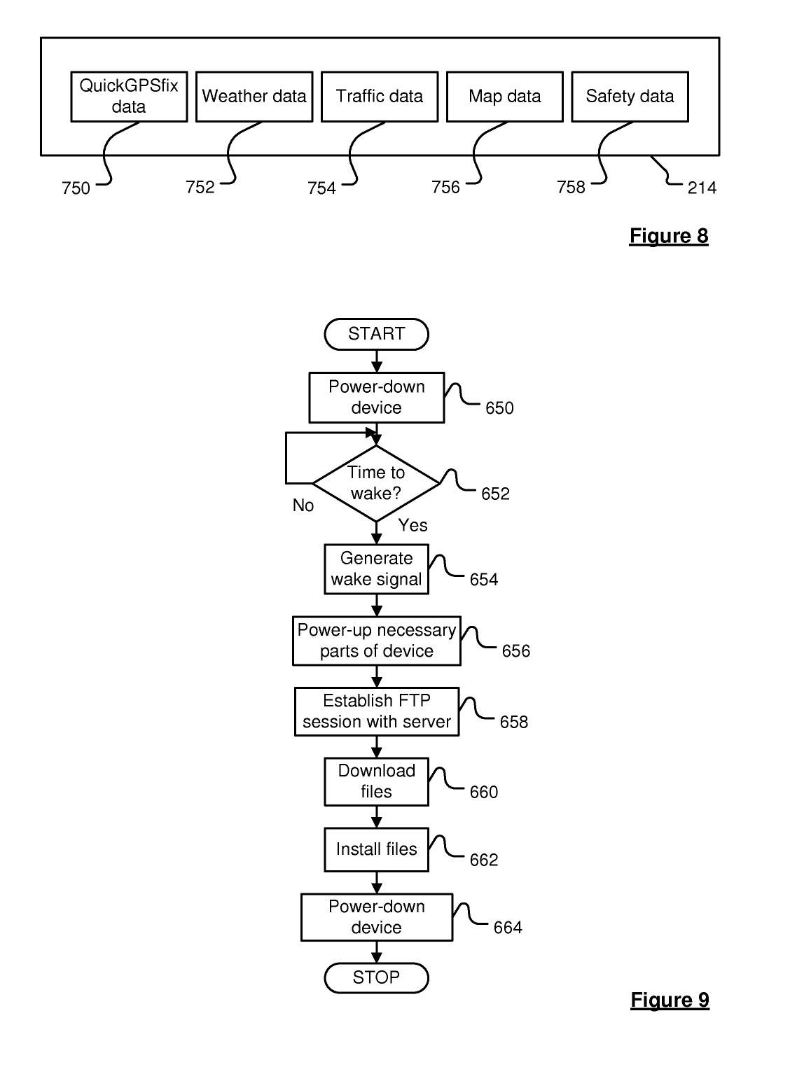

Turning to FIG. 8, the updatable data stored in the memory 214 comprises a number of data files that serve different purposes in respect of operation of the navigation device 200. In particular, the memory 214 stores calibration data, for example data relating to a position of a satellite, such as the QuickGPSfix data 750. The memory 214 also stores environmental data, for example meteorological data, such as data relating to weather 752. The memory 214 additionally stores traffic data 754. In this example, the traffic data 754 is static, for example a snapshot of traffic and so time-invariant. The updatable data also comprises map data 756 and/or safety data 758, for example data relating to a location of a safety camera, such as data relating to a last known location of a mobile safety camera. Of course, the skilled person should appreciate that the updatable data can comprise all or some of the above-mentioned data files as well as other types of data.

In operation (FIG. 9), the activation module 228 has been set via the operational environment in the manner described above to awaken at a predetermined time prior to an activation time known to the user when the navigation device 200 is powered up for use by the user. The user has placed the navigation device 200 in a standby or sleep mode (Step 650) constituting the first level of operation and in which the navigation device 200 consumes a minimal amount of power as compared to during normal operation in order only to power essential functions of the navigation device 200. In this regard, the activation module 228 constitutes one of the essential functions requiring power and, in any event, the activation module 228 is arranged to minimise power consumption.

The activation module 228 periodically monitors output of the clock circuit in order to determine whether the wake time set by the user has been reached (Step 652). The activation module continues to monitor the clock circuit until the predetermined time set by the user has been reached. Upon reaching the predetermined time, the activation module 228 generates (Step 654) the wake signal that is received by the wake input 230 of the processor 202. The receipt of the wake signal causes the processor 202 to power-up and power-up other parts of the navigation device 200 necessary for supporting data download and installation, for example the wireless communications interface 232, which communicates with the wireless router 704. Consequently, the parts of the navigation device 200, or if required all circuitry of the navigation device 200, transition from the first level of operation to the second level of operation. The operational environment therefore boots up or restores from a last stored state, and the operational environment further responds to the receipt by the processor 202 of the wake signal by causing the FTP module 508 to cooperate with the wireless communications interface 232 in order to establish (Step 658) an FTP session with the server 400 via the wireless LAN and the network provided by the ISP 702 in order to determine firstly whether the server 400 has files relating to updates that are more recent than those already stored by the navigation device 200 in the memory 214.

Once files to be downloaded from the server 400 have been identified, the FTP session is used to download the download data (Step 660). Once downloaded, the FTP session is terminated and the downloaded data files are, if necessary, unpackaged, for example “unzipped” and used to replace corresponding files stored in the memory 214. If necessary, where the download data needs to be used as part of an install process, any necessary install processes are executed (Step 662), for example where new map update data has been downloaded and requires integration into existing map data. Of course, all of the download data can simply be downloaded without identifying those parts that are already stored in the memory 214 of the navigation device 200.

Once the download data has been downloaded and any necessary postprocessing performed, the operational environment instructs the awakened parts of the navigation device 200 to power-down completely or enter the standby or dormant states in order to return to the first level of operation.

In another embodiment, instead of the user setting the predetermined time via the operational environment, the operational environment learns the activation time from use of the navigation device 200 by the user.

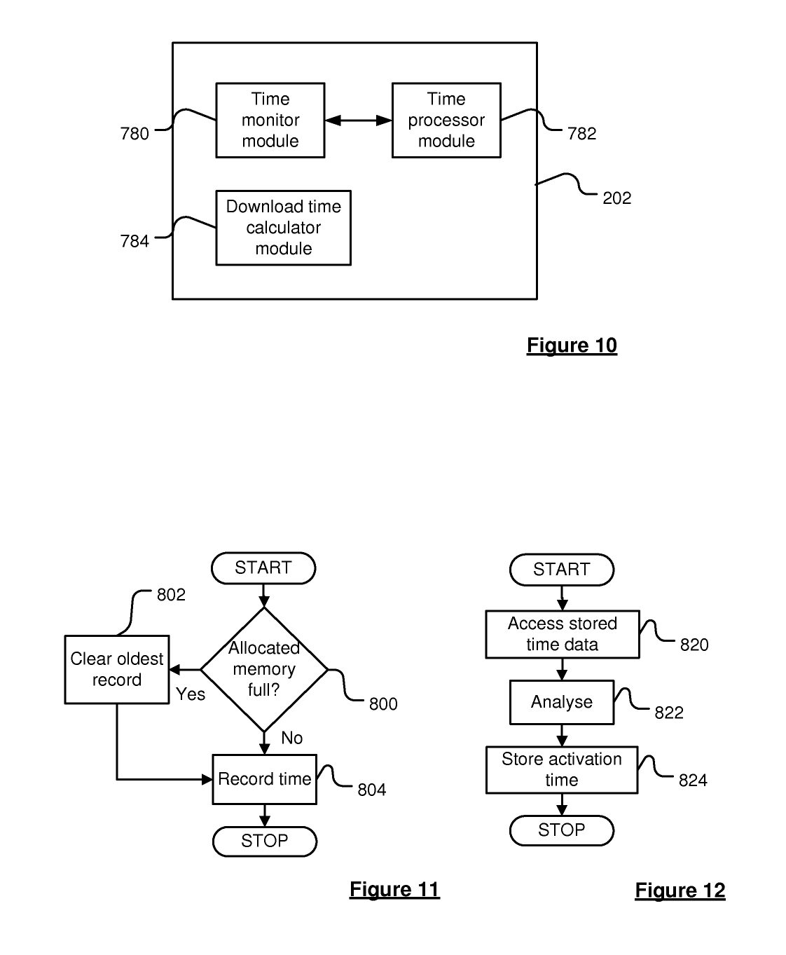

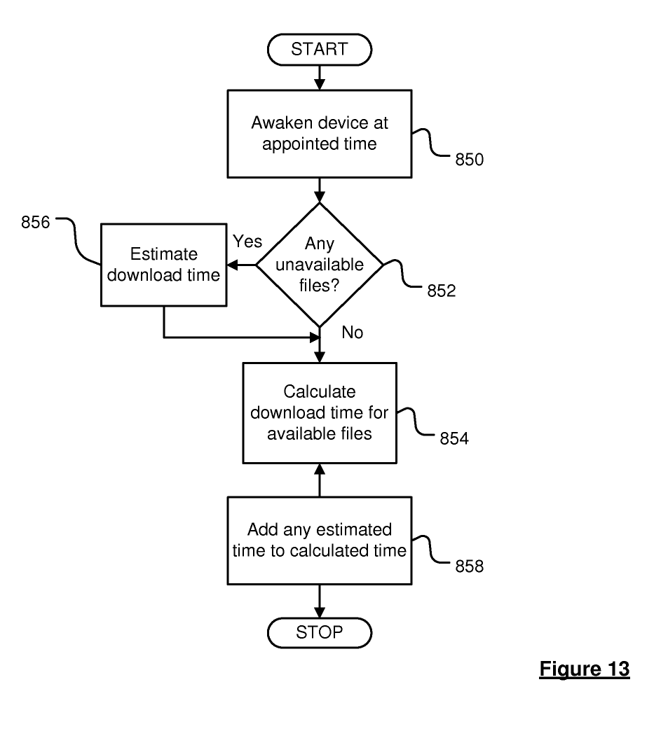

Referring to FIG. 10, the processor 202 supports a time monitor module 780 capable of communicating with a time processor module 782. Turning to FIG. 11, the time monitor module 780 records times at which the user powers-up the navigation device 200 for use thereof. In this respect, when the navigation device 200 is activated, the time monitor module 780 checks (Step 800) allocated memory space to ensure that the allocated memory space is not full. If the allocated memory space is full, the time monitor module 780 erases (Step 802) the oldest time entry in the allocated memory before recording (Step 804) the time of device activation in the memory 214. The time processor module 782 then periodically accesses (Step 820—FIG. 12) the memory 214 in order to access the stored times in order to analyse the time data stored. In this respect, time processor module 782 is arranged to perform a statistical analysis (Step 822) in respect of the time data stored, for example calculation of a mean time, a mode time (most frequent) or an earliest time at which the navigation device transitions to the second level of operation at the behest of the user. The earliest time that the transition to the second level of operation is observed to occur can be relative to a fixed point in a day or night, for example about midnight. The result of the above processing of the time data is stored (Step 824) as the activation time to be used.

As a refinement to the above technique, the time processor module 782 can process the time data stored further so as to discount or mitigate influence of substantially anomalous activation times observed, for example by determining a cluster of activation times and discounting or ignoring activation times that are more than a threshold amount of time in excess of a maximum time observed with respect to the cluster of activation times. The threshold value can be determined by way of a function, for example a multiple or percentage of time.

Once the activation time to be used has been determined, the predetermined time is determined by calculating a time that precedes the activation time determined by a predetermined pre-activation time period. The pre-activation time period is, in this example, a fixed period of time, for example 1 hour. However, the pre-activation time period can be selectable by the user via the operational environment or by the server 400. Once the predetermined time has been calculated, the predetermined time is used in a like manner to that described above in relation to the previous embodiment to trigger the transition from the first level of operation to the second level of operation.

In a further embodiment, the processor 202 supports a download time calculator module 784 to determine a quantity of data to be downloaded from the server 400 and to determine an amount of time required to download the download data.

In operation, once the relevant parts of the navigation device 200 have transitioned to the second level of operation as described previously, the download time calculator module 784 in cooperation with the FTP module 508 determines the size of the download data to be downloaded. As mentioned above, the download data can be stored as separate units of data that can be separately downloaded.

In order to cater for circumstances where the total size of the download data exceeds the time difference between the predetermined time and the activation time, the download time calculation module 784 calculates the amount of time required to download all of the download data as well as individual separately downloadable parts of the download data. The download time calculator module 784 uses information available concerning the download speed typically achievable via the ISP 702. The download speed information can either be provided in advance by the user via the operational environment or by a separate function of the download time calculator module 784 that determines previous download speeds experienced or by conducting a download speed test.

The download time calculator module 784 then prioritises download of the most important parts of the download data, for example safety data and/or traffic data. The data to be downloaded first when insufficient time is available for download of all the download data can be prioritised by selection of data type by the user via the operational environment.

Aspects of the download data that are not a priority for download can then be deferred for download at a time when more time is available and/or a higher download speed is achievable. As a precautionary measure, the download time calculator module 784 can be arranged to include a margin for delay into the download time calculated in order to account for variations in download speed and temporary disruptions in connectivity.

In yet another embodiment, the download time calculated by the download time calculator module 784 can be used to determine the pre-activation time period mentioned above. Referring to FIG. 13, in order to accommodate this functionality, the activation module 228 is programmed to awaken (Step 850) the navigation device 200 at an initial time well in advance of the activation time of the navigation device 200. For example, the amount of time in advance of the activation time can be a maximum amount of time in excess of an anticipated download time or a set time when the navigation device 200 is unlikely to be used, for example between about 2.00 am and about 4.00 am. This time can, optionally, be set by the user via the operational environment to accommodate use habits of the user, for example a user that works a night shift.

When awoken, the time calculator module 784 determines (Step 852) whether any files, for example traffic data files, are not yet available for download. If all files are available for download then the download time calculator module 784 calculates the download file for available files (Step 854). Otherwise, the download time calculator module 784 makes a generous allowance for the amount of time required to download the unavailable files (Step 856) and then calculates (Step 854) the download time in respect of the available files for download before adding (Step 858) the estimated time to the calculated download time in order to obtain the pre-activation time period. The pre-activation time period is then used in the manner described above in relation to previous embodiments in order to calculate the predetermined time using either the pre-set activation time set by the user or the learnt activation time. Optionally, whilst in communication with the server 400, the navigation device 200 can download available download data.

It should be appreciated that, in relation to the above embodiments, due to the range of modern wireless routers and similar devices, the range can be sufficient to provide coverage to a navigation device located within a vehicle, for example an automobile. In such circumstances, such navigation devices can be integrated with the vehicle, and not portable by the user outside the vehicle.

Although reference has been made herein to data files, the skilled person should appreciate that the “data” can be executable code.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above embodiments have been described in the context of the subscription-free communications network being a wireless LAN, the subscription-free communications network can be a Personal Area Network (PAN) supported by a an alternative technology, for example a communications network supported by a Bluetooth™ base station operating in accordance with the Bluetooth™ communications standard.

For example, whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation device capable of a first level of operation and a second level of operation, the device comprising:
a processing resource arranged to support, when in use, an operational environment:
a data store operably coupled to the processing resource and arranged to store updatable data useable by the operational environment; and
a communications network interface for supporting connectivity with a subscription-free communications network; wherein the first level of operation consumes less power than the second level of operation; the processing resource supports an activation module arranged to cause a transition from the first level of operation to the second level of operation; and the processing resource is arranged to use the communications network interface following the transition to the second level of operation in order to download data.

2. A device as claimed in claim 1, wherein the processing resource is arranged to use at least part of the downloaded data to update at least part of the updatable data.

3. A device as claimed in claim 1, wherein the first level of operation is a dormant state.

4. A device as claimed in claim 1, wherein the second level of operation is an active state.

5. A device as claimed in claim 1, wherein the subscription-free communications network is capable of supporting communication via another communications network, the download of the data being via both the subscription-free communications network and the another communications network.

6. A device as claimed in claim 5, wherein the another communications network is subscription based.

7. A device as claimed in claim 1, wherein the communications network interface is a wireless local area network communications interface.

8. A device as claimed in claim 1, wherein the updatable data is dynamic data.

9. A device as claimed in claim 1, wherein the updatable data comprises calibration data.

10. A device as claimed in claim 1, wherein at least part of the updatable data relates to traffic data.

11. A device as claimed in claim 1, wherein the updatable data comprises map data.

12. A device as claimed in claim 1, wherein the communications network interface is used in response to the transition to the second level of operation.

13. A device as claimed in claim 1, wherein the activation module is arranged to cause the transition at a predetermined time.

14. A device as claimed in claim 13, wherein the processing resource is arranged to learn an activation time during a day or night when a user causes the navigation device to transition from the first level of operation to the second level of operation.

15. A device as claimed in claim 14, wherein the processing resource is arranged to observe a plurality of times when the transition caused by the user takes place and to calculate the activation time from the plurality of times observed.

16. A device as claimed in claim 15, wherein the plurality of times is averaged in order to yield the activation time.

17. A device as claimed in claim 14, wherein the predetermined time is determined to precede the activation time by a pre-activation time period.

18. A device as claimed in claim 14, wherein the processing resource is arranged to determine the size of the data to be downloaded and use the size of the data to be downloaded to determine whether sufficient time remains before the activation time in order to download the data.

19. A device as claimed in claim 14, wherein the data to be downloaded comprises separately downloadable parts, the processing resource being arranged to at least one of prioritise download of the separately downloadable parts and defer download of a downloadable part of the separately downloadable parts in response to insufficient time being available to download all the separately downloadable parts before the activation time.

20. A device as claimed in claim 17, wherein the processing resource is arranged to determine the size of the data to be downloaded and use the size of the data to be downloaded to determine the pre-activation time period.

21. A device as claimed in claim 20, wherein the processing resource is arranged to determine the pre-activation time period using the determined size of the data to be downloaded and knowledge of an obtainable download speed.

22. A communications system comprising: a navigation device as claimed in claim 1; a first communications network capable of communicating with the navigation device; a second communications network operably coupled to the first communications network and capable of passing communications between the navigation device and a remote source of data; wherein the first communications network is subscription-free.

23. A method of updating a navigation device capable of a first level of operation and a second level of operation, the method comprising:
supporting an operational environment;
storing updatable data in a data store useable by the operational environment:
providing a communications network interface for supporting connectivity with a subscription-free communications network;
providing an activation module to cause a transition from the first level of operation to the second level of operation; and
using the communications network interface following the transition to the second level of operation in order to download data; wherein the first level of operation consumes less power than the second level of operation.

24. A computer program element comprising computer program code segments to, when run on a computer, make the computer execute the method as claimed in claim 23.

25. A computer program element as claimed in claim 24, embodied on a computer readable medium.

26. A device as claimed in claim 2, wherein the first level of operation is a dormant state.

27. A device as claimed in claim 2, wherein the second level of operation is an active state.

28. A device as claimed in claim 1, wherein the processing resource is arranged to learn an activation time during a day or night when a user causes the navigation device to transition from the first level of operation to the second level of operation.
